(19) United States
(12) Patent Application Publication
(10) Pub. No.: US 2024/0184277 A1
(43) Pub. Date: Jun. 6, 2024

(54) SHARED DATA INDUCED QUALITY CONTROL SYSTEM FOR MATERIALS

(71) Applicant: Versum Materials US, LLC, Tempe, AZ (US)

(72) Inventors: Safa Kutup KURT, Darmstadt (DE); Rolf ROTH, Darmstadt (DE); Laura MATZ, Tempe, AZ (US); Samuel WOOD, Tempe, AZ (US); John WILLIAMS, Tempe, AZ (US)

(21) Appl. No.: 18/282,709

(22) PCT Filed: Mar. 17, 2022
(86) PCT No.: PCT/EP2022/056945

§ 371 Date: Sep. 18, 2023

Related U.S. Application Data
(60) Provisional application No. 63/163,460, filed on Mar. 19, 2021.
(60) Provisional application No. 63/218,117, filed on Jul. 2, 2021.

(51) Int. Cl. G05B 19/418

(52) U.S. Cl. CPC G05B 19/41875; G05B 2219/32368

(57) ABSTRACT

A method for developing or improving a process for producing a product from a material comprising steps of acquiring raw material data from at least two different sources for the production process and its relevant parameters by using a Data Collecting computer; using the acquired raw material data related to the production process to perform a Process Mapping step by using a Process Mapping computer; assigning the acquired raw material data related to the relevant parameters of the production process to its corresponding process parts by performing a Data Mapping step by using a Data Mapping computer; analyzing the therefore mapped process description with a specific software performed on an Analyzing computer thereby identifying and validating one or more existing characteristics related to the quality or performance of the production process; and using the identified and validated characteristics to develop the production process or improve its performance.

### CROSS-REFERENCE TO RELATED APPLICATIONS

This application is a National stage application (under 35 U.S.C. § 371) of PCT/EP2022/056945, filed Mar. 17, 2022, which claims benefit of U.S. Application Nos. 63/163,460, filed Mar. 19, 2021, and 63/218,117, filed Jul. 2, 2021, all of which are incorporated herein by reference in their entirety.

### TECHNICAL FIELD

The disclosed subject matter relates to a method and a system for ensuring product quality in a process for producing a product from one or more materials. The disclosed subject matter belongs to the technical fields of process automation, quality control, and supply chain optimization.

### BACKGROUND

Modern production processes are very complex matters which are influenced by many variables related to raw material inputs, equipment and tooling, human interactions, and so on. Even the slightest variations can lead to significant quality issues in the finished product, making them inferior or even unsalable. This may result in unacceptable deficiencies for the producer and/or customer, especially in highly regulated industries such as chemical or pharmaceutical. There are many ways known in the state of the art to improve the production process and ensure the quality of the fabricated products. Nowadays, most of these methods are data-driven, where the relevant parameters are monitored and controlled based on data collected from the production process.

One of those approaches is the Six Sigma method which, in the control phase, focuses primarily on the use of Statistical Process Control (SPC) to identify assignable causes of variation in a process of interest. Say the output of a process is a random variable with population mean u and standard deviation σ. If one samples with replacement from the process output and the sample size is sufficiently large then the distribution of sample means will be approximately normal, regardless of the distribution of the parent population. Furthermore, the arithmetic average of the sample means provides a point estimate of the population mean, and the standard deviation of the sample means can be used to estimate the population standard deviation. These properties are known in statistics as the Central Limit Theorem, and by virtue of this one can calculate control limits that set upper and lower bounds for the expected output from a given process. A measured value that exceeds these control limits is a statistically significant event that warrants further investigation to identify and address the root cause. In other words, the value deviates from the expected distribution to such a degree that it is extremely unlikely that it was produced by the same process as the preceding data, and thus there must be some assignable cause external to the process that is responsible for the deviation. The distribution of the process variable being measured can also be compared to the spread of known specification limits to quantify process capability. Given a specific process target and accompanying tolerances for error, one can directly calculate a capability index ratio that indicates the ability of the process to produce output of acceptable quality.

From the U.S. Pat. No. 7,181,353 B2, a method for integrating Six Sigma into an inspection receiving process of outsourced products is known and includes the following steps: defining specification limits for product acceptance criteria: identifying and reporting a substandard product to authorized personnel for disposition via a MES (manufacturing execution system) and SCADA (supervisory control and data acquisition): preparing a report containing historical data, identifying root cause and assigning a corrective action: segregating the substandard product and documenting the substandard product in the MES: disposing of the substandard product: documenting and recording the corrective action in the MES: and outlining a method of recovery and eliminating a non-conforming incoming product. The present method may provide a device for a Closed Loop Corrective Action (CLCA).

The U.S. Pat. No. 6,675,135 B1 discloses a method to be used during a product development procedure, where the procedure includes a series of consecutive development phases and the product includes at least two critical-to-quality characteristics (CTQs). The method is for generating a confidence matrix which can be used to increase a product quality through product design. A user initially provides product limits and thereafter provides additional development information during each consecutive development phase. During at least two of the development phases and for each CTQ, development information is used to determine a quality factor which is indicative of the probability that the product will be within the specified limits. A confidence interval is identified which is indicative of the probability that the quality factor is accurate. Then, quality factors, CTQs and confidence factors are arranged such that the CTQs and factors are correlated.

Those known methods cling very tight to the Six Sigma approach, concentrating on specific steps of that method to ensure set quality standards and are therefore less suitable to be used in alternative approaches which differ from that method. Furthermore Six Sigma is a process improvement method that relies on the “voice of the customer” and prioritization and filtering via expert input. It usually does not include modern data driven approaches with Machine Learning tools. Therefore it has deficiencies when being used with those automatized methods, e.g. to double check human expert analyzes. Some have also stated that the Six Sigma standard does not go far enough to really guarantee defect free products. Also, the proposed approach is not limited to predefined scope items. In the definition phase of the Six Sigma process, items for scope-in and scope-out are clearly defined by the experts who are involved in the project team. Here, physics-first approach is used to narrow down to suspicious areas which may relate with the voice of customer. The out of scope items may or may not be investigated in with further projects. Thus, even though the issue can be solved within the project frame in the Six Sigma approach, there is no systematic way or method to consider the out of scope items. This might hinder the discover of the underlying root-cause of the issue in long-term. A sustainable problem-solving for upcoming deviations may not be provided.

Another point is that in the case of different productions sites with different production processes and philosophies, e.g. like a material provider and an actual producer, the six sigma approach leads to or better requires aligning and/or merging those two different production processes. This can be difficult and causing a lot of effort dependent on how different the processes are.

A specific problem in this field is furthermore that the unwanted variation in finished goods quality is driven primarily by raw material inputs rather than only process variables. Raw material quality is highly variable, and suboptimal lot selections for product batches can lead to failing customer acceptance limits and a need to scrap or rework the produced batch.

Another specific point regarding this field is that the feature size of the circuit components has been fast decreased while the number of metal layers has been fast increased resulting in device topographies to exhibit features that inhibited conformal deposition. The need for the global surface planarization of the various thin films layers that constitute the integrated circuit (IC) has tremendously increased.

Chemical mechanical planarization is a process in which the surface of a substrate is smoothed and planarized through the combined action of chemical and physical forces on the surface. CMP combines the best of both techniques while avoiding the pitfalls. Whereas purely abrasive grinding of the surface would cause too much physical damage and purely chemical etching would not achieve planarization, the combined action of the two produces a well-planarized surface with minimal damage.

Chemical mechanical planarization (CMP) has a number of advantages for semiconductor device manufacturing beyond the fact that it reduces rough topography to a planarized state. CMP allows the device manufacturer to achieve global planarization of the entire wafer surface in a single step. The approach can be used to planarize a wide range of materials, from different metals to different oxide films. Chemical mechanical polishing is the planarization method that has been selected by the semiconductor industry today.

A chemical mechanical planarization tool consists of a rotating platen covered by a polishing pad. The wafer is mounted face down in a carrier that is pressed against the pad with a specified force. This force can be provided using either a defined and regulated gas pressure or a mechanical backing pressure system. The wafer also rotates during the polishing process. The polishing pad is saturated with a slurry that is pumped on to the pad. Polishing of the wafer surface occurs as the wafer is rotated on its own axis and moved about the polishing pad while being forced against the pad. During the polishing process, high points on the wafer surface are naturally subjected to more pressure and therefore more abrasive force. This combines with the action of the chemical etchant to produce an enhanced removal rate for material at the high points relative to material at low points in the surface topography. This produces the planarization effect in the process.

A chemical mechanical planarization slurry usually comprises abrasive particles to provide physical forces on the surface: chemical additives to promote the removal rate: chemical additives to reduce dishing: chemical additives to reduce erosion: oxidizers to chemically etch material: activators or a catalysts to interact with oxidizers and facilitate the formation of free radicals: corrosion inhibitor: stabilizers to facilitate or promote stabilization of the composition against settling, flocculation (including precipitation, aggregation or agglomeration of particles, and the like) and decomposition: a surfactant to aid in protecting the wafer surface during and after polishing to reduce defects in the wafer surface: chelating agents: to enhance affinity of chelating ligands for metal cations and/or to prevent build-up of metal ions on pads which causes pad staining and instability in removal rates: pH adjuster, biocides to control biological growth: a solvent such as water. CMP slurries use chemical materials heavily.

To achieve efficient planarization at miniaturized device dimensions, there is a need for a better understanding and thus a better control of the physics, chemistry and the complex interplay of tribo-mechanical phenomena occurring at the interface of the pad and wafer in presence of the fluid slurry.

Production processes for CMP slurries are thus very complex matters which are dependent on many parameters and variables regarding the involved materials, tools, production machines, responsible workers and so on. It is therefore necessary to characterize, optimize and model the process.

To improve the production process and ensure the quality of the products there are many ways known in the state of the art to supervise the whole process. Most of them are nowadays data-driven where the relevant parameters and variables of the production process are monitored and checked regularly if they do not meet their target values.

To comply with and enhance such state of the art it would therefore be desirable to find a new approach to operate automatic production management systems which further enhances the production process regarding quality and reliability, and which can handle different processes efficiently.

Therefore it would be desirable to find a new approach to operate automatic production management systems which further enhances the production process regarding the resulting product quality dependent on the raw material input.

### SUMMARY

The above-described tasks can be solved by a method for ensuring product quality in a process for producing a product from a material comprising the following steps of acquiring raw material and finished good quality data from at least two different sources for the production process and its relevant parameters by using a Data Collecting computer: map the acquired raw material data to the production process in a Process Mapping step by using a Process Mapping computer, analyzing the therefore mapped process description with a specific software performed on an Analyzing computer thereby identifying and validating one or more existing characteristics related to the quality of the produced product: and using the identified and validated characteristics to choose the most suitable, available raw material data to improve the resulting product quality. Importantly for the subject disclosure, is to first track all the possibly relevant data related to the desired production process which shall be created or improved, in particular the raw material data described by its specific parameters. This data is collected from at least two different sources, like different production sites, internal quality controls, supplier certificate of analysis (CoA) and contains beside the raw material data e.g. internal process data and customer data. One of the two different sources is usually the raw material provider as they have the most knowledge about the material. The different sources can of course also be located in the same production site and originate e.g. in two different production machines. Therefore the data can be different regarding to structure, format, syntax etc. In the process mapping step the available data relating to the desired process is then used to establish and define process structures like the specific process method steps and the required process components. It also includes the mapping of the data from the first and the other sources so both different data types can be processed. Point is here to don't simply align the data from the different sources to create on single process but to keep it separately and map it together so it can be processed and analyzed later on. The available raw material data can contain material data of suppliers like CoA (Certificate of Analysis, e.g. metals), additional internal raw material (quality) measurements (e.g. trace metal impurity levels and purity levels), and batch pedigree (which raw material lots and amounts) were collated into a single data file. If process data is used it can describe for instance an already existing production process which is supposed to be improved by the disclosed method. Or it could contain data describing a wanted new production process, like available production machines and the like, for creating the new production process to be most efficient. In the data mapping step the acquired raw material data relating to its parameters is then assigned or mapped to its process counterparts to which these parameters are related to from the created process in the process mapping step. The two method steps of process and data mapping can be performed simultaneously or the data mapping step can be executed after the process mapping step. After the process is successfully defined including the assigned raw material data the actual process evaluation takes place in the analyzing step. During that evaluation a special software is fed with the mapped raw material data and eventually process data and analyzes it's content searching for specific patterns and dependencies which disclose characteristics of a process which can be used to improve the established process. The software can use different kinds of algorithms. It could use for instance an artificial intelligence approach like supervised, unsupervised, semi-supervised and reinforcement learning etc. Which one is most suitable depends on the kind of available raw material and ev. process data. Important is that the algorithm gets trained to find patterns or identify influencing factors of the process. The approach can be implemented by using Gradient Boosted Decision Trees, artificial neural networks (ANN) or other. This ANN could then further improve its performance by learning on its fed, mapped raw material data. But also other AI software approaches are possible. The software could alternatively also use approaches from classical statistics, if they are suitable to determine the characteristics. Also physics-based and mechanistic models, like mass balances can be used. Which approach is then most suitable and therefore chosen depends on the specific case and the respective kind of raw material data. After the mapped and analyzed process is created and the characteristics are identified those characteristics are applied to the production process, therefore improving it and the resulting product quality. Those characteristics can be used additionally to insights gained from process experts to improve the product quality. In particular, based on a selection of certain raw material lots with corresponding characteristics, the models will give a prediction of the finished goods quality. By variation of different lots of the same raw material, different predictions for the finished goods quality are obtained. By selection of the right raw material lots, a final product quality, best suited for the customer can be selected. The better the software is able to determine the characteristics the less expertise from human experts is necessary. All those method steps are performed by computers which are configured to perform the method steps. The complete process may be automated by mathematical optimization techniques, where the user only provides the finished good quality specification limits and a weighting how a deviation from these limits should be penalized. The optimization algorithm then picks the most suited raw material lot, based on the user settings. While complete automation of the method steps is desired which depends on the abilities of the used hardware and software, human support, for instance in evaluating the acquired data or the identified characteristics, might be necessary. The minimum requirement for the involved computers includes their ability to process, transfer and display the acquired raw material and ev. process data and to perform the software analyzing step. The computers itself can be different computers at different locations which are connected to each other via internet, local networks etc. or some or all of them can be identical.

The scope of our approach is not limited to this. In long-term, the learnings from a use-case is cascaded down to R&D for product development and also cascaded back to procurement (to suppliers). In the light of these learnings, experts aim to control the purchasing of the best material from our supplier, while investigating the specification of the next generation material for our customer's new application technology in R&D.

Advantageous and therefore preferred further developments of this disclosure emerge from the associated sub claims and from the description and the associated drawings.

One of those preferred further developments of the disclosed method comprise that for acquiring the data for the production process and its relevant parameters the process data is retrieved from a database which is connected to the Data Collecting computer, created by observing the process using data collecting devices, notably sensors, and/or provided by a human user. Which of these approaches in which combination depends on the target production process. Usually the process data is of a better quality if at least some current data from sensors is involved.

Another one of those preferred further developments of the disclosed method comprise that acquiring the data by observing the production process is done during previous executions of the process and/or during a current execution after using the identified and validated characteristics. By doing that, it is ensured that the acquired data is always up-to-date. It also greatly improves the efficiency of using AI methods like ANNs if they are trained and used with up-to-date information.

Another one of those preferred further developments of the disclosed method comprise that the Process Mapping is performed by describing the structure of the production process or its pre-stages from the different sources including necessary components, process sequences or process steps, ingredients, like raw material and the like. By doing so the process is defined and can afterwards be analyzed by the software to create or improve its performance.

Another one of those preferred further developments of the disclosed method comprise that the Data Mapping is performed by assigning the acquired process parameter from all involved sites, like temperature, mixing ratio of raw materials, time, and the like, to its corresponding process components and process sequences or steps. While the process mapping defines the process structure, its necessary components and the like the data mapping assigns its parameters to their relevant process components which are defined in the process mapping. The therefore prepared process data is then ready to be analyzed by the software performance relevant characteristics.

Another one of those preferred further developments of the disclosed method comprise that analyzing the data is performed by the software using supervised and unsupervised algorithms including a data analysis framework with a data model using approaches like Multivariate Analysis like PLS regression, PCA, Random Forest, XGBoost, and artificial Neural Networks, PLS regression and/or Random Forest or the like, or using supervised and/or unsupervised static algorithms. Both kinds of algorithms— supervised and AI related or not—can be used by the software. But the more complex the process in question is, the more difficult it becomes to provide a software with a non-learning approach which really identifies all the wanted process characteristics. Those are more suitable for but of course not limited to less complex production processes or if only specific defined process parts need to be evaluated.

Another one of those preferred further developments of the disclosed method comprise that analyzing the data is performed using mechanistic models, physics based models, models based on (partial) differential equations and models based on quantum chemical computations. The method is not limited to those model types but they are the most suitable ones.

Another one of those preferred further developments of the disclosed method comprise that wherein the structure of the supervised algorithms is the result of training the PLS regression, PCA, Random Forest, XGBoost and artificial neural networks, or the like with the results of the process description from the Process and Data Mapping. Artificial Neural Network (ANN) or the like are very suitable to evaluate those complex production processes because they cannot only be trained with the mapped data from the process and data mapping steps and therefore be adapted to the production process no matter how complex it gets. They can also be used in several re-iterations of the disclosed method getting better and better adapted the more often they are used to identify the process characteristics.

Another one of those preferred further developments of the disclosed method comprise that the process data is acquired by examining the at least two different sources either manually by a user who inputs this data in the Data Collecting computer or automatically by a Data Collecting Software performed on either the Data Collecting computer or a separate computer which is connected to it with the Data Collecting Software transmitting it to the Data Collecting computer. Which one of those approaches is used, depends on the restrictions and abilities of the used hardware and software. The more data acquiring can be done automatically the better.

Another one of those preferred further developments of the disclosed method comprise that as at least two different sources at least two different production sites are used. Those different sites could be for instance one site producing the raw material for the products which is supervised by a material provider while the other site is the actual production plant.

Another one of those preferred further developments of the disclosed method comprise that the characteristics are root causes, like maintenance problems, or previously unknown process issues related to the performance or quality of the process, like specific setting parameters for the production process. Root causes are mainly relevant when the disclosed subject matter is used to improve existing production processes, especially to solve a specific problem with it. But the disclosed subject matter can also be used to create new production processes by identifying so far unknown connections between process parameters and/or components and by therefore solving issues or open up new potentials which have not been thought about before.

Another one of those preferred further developments of the disclosed method comprise that the production data from the at least two involved production sites comprises raw material data like specific quality parameters or metal impurity and purity levels, P&ID charts, or in-process-data like sensor data including temperatures, flows, tank levels etc. That data can be generally assigned to two different categories. One is the raw material related data like CoA etc., which is necessary for performing the process mapping thus defining the process. The other category comprise of the process parameters, like sensor data and so on, which feeds the data mapping step.

Another one of those preferred further developments of the disclosed method comprise that a user interface is implemented which uses a data platform on the Analyzing computer for a preprocessing of the acquired raw material data before applying the specific software performed and writes the results to an database from where a dedicated dashboard retrieves the data to provide it to user for performing a Raw Material Review. The user interface is also hosted by the Analyzing Computer. The dashboard on the other hand is organized preferably by a Tableau software: but also any other suitable software can be used.

Another one of those preferred further developments of the disclosed method comprise that the user interface displays the contributions of different raw materials to the prediction of a certain quality measurement to indicate the most relevant raw materials.

Another one of those preferred further developments of the disclosed method comprise that the production process is a semiconductor device manufacturing process using Chemical mechanical planarization. While the disclosed method can be used to improve every production process where a product is created from different raw materials, it is especially suitable to be used in semiconductor device manufacturing processes, preferably those ones which use CMP processes.

A further component of the present disclosure is a system for developing or improving a process for producing a product from a material comprising a Data Collecting computer with a connected database and/or at least two production sites being used to acquire process data from the at least two production sites for the production process and its relevant parameters, a Process Mapping computer being used to perform a Process Mapping step with the acquired process data related to the production process, a Data Mapping computer being used to assign the acquired process data related to the relevant parameters of the production process to its corresponding process parts by performing a Data Mapping step, an Analyzing computer including a specific software performed on it using a supervised algorithms including a data analysis framework with a data model wherein the software analyzes the therefore mapped process data to identify and validate one or more existing characteristics related to the quality or performance of the production process and a Process Performing computer being used to create the production process and/or improve its performance on the at least two production sites by applying the identified and validated characteristics. That system performs the disclosed method. As already explained the mentioned computers in the system can be established as separate system components or be the same computer or a combination thereof whatever suits best. At least the Analyzing computer with the specific software should preferably be a separate computer. If the raw material data from the at least two different production sites is acquired automatically then the Data Collecting computer needs to be connected with a kind of an automatic control that is computer-based in each of the production sites. There the algorithm on the Analyzing computer writes back into the respective system control to the production crew which lot id should be used for the production. The types of the used computers then depends on the requirements of the performed method. If most of the method steps are performed by human users a kind of personal computer, tablet, mobile phone or the like with a display and some data input means or interfaces so the users can provide the data to the computers and the used software should be used. The more automated the method is performed also other types of computers like industrial pcs, microcontrollers, single-board or embedded computers in general can be used. A clear defined data interface and data transfer network, like ethernet, bus-systems or wireless alternatives, for automatic data transmissions gets then more important.

One preferred further developments of the disclosed system comprise that at least one of at least two sites is a factory for producing chemicals, pharmaceuticals or the like and at least one of the other sites is a chemical material provider and/or distributor. In this case both sites need to be connected to the Data Collecting computer and/or its respective database to provide the necessary process data if there is an automatic data transfer required. If, due to the different site owners only secured, non-automated data transfer is possible, the connection is more indirect e.g. by transferring secure data storages and the like.

Another one of those preferred further developments of the disclosed system comprise that the Data Collecting computer is hosting a computer based digital platform which is used to acquire the process data from the at least two production sites. Another possibility of acquiring the necessary process data lies in using a digital platform for the data acquiring to which all participating production sites can transfer their process relevant data. The platform will then manage this data and distribute it to the respective Process and/or Mapping computer to perform their Mapping steps.

Another one of those preferred further developments of the disclosed system comprise that the Process Mapping computer and the Data Mapping computer are supporting input terminals for human users to perform the Process Mapping and Data Mapping step, while the Analyzing computer is a server which hosts the software with the supervised and/or unsupervised algorithm, notably a XGBoost, Random Forest or artificial neural network, and the Process Performing computer is part of or identical to the respective computer based control terminal for the at least two production sites. Like already mentioned if human users are required to perform part of the method steps the used computers must provide respective in- and output means, like keyboards, mouse, screens, and the like, and respective software to process this input. If an ANN is used by the software a suitable computer hardware for this ANN is required.

A further component of the hereby disclosed subject matter is an XGBoost, Random Forest or artificial neural network, or other AI approach which structure is dependent on being trained with specific training data which is created acquiring process data from at least two different sources for a production process and its relevant parameters via a Data Collecting computer, using the acquired process data related to the production process to perform a Process Mapping step via a Process Mapping computer, assigning the acquired process data related to the relevant parameters of the production process to its corresponding process parts by performing a Data Mapping step via a Data Mapping computer and creating training data from those mapped process data. The therefore created training data is then used to train the software and establish its necessary internal structure so it can be used to analyze the mapped process data to identify the required process characteristics. By providing the software with the real process data it is further trained and improves its analyzing performance.

Another component of the disclosed subject matter is a Computer program comprising instructions which cause the involved computers to carry out the following method steps of acquiring raw material data from at least two different sources for the production process and its relevant parameters by using a Data Collecting computer: using the acquired raw material data related to the production process to perform a Process Mapping step by using a Process Mapping computer: assigning the acquired raw material data related to the relevant parameters of the production process to its corresponding process parts by performing a Data Mapping step by using a Data Mapping computer: analyzing the therefore mapped process description process data with a specific software performed on an Analyzing computer thereby identifying and validating one or more existing characteristics related to the quality or performance of the production process: and using the identified and validated characteristics to develop the production process or improve its performance. The program parts responsible for the single method steps are running on the respective computer parts. How the program itself is partitioned depends on the computer hardware being involved. It is possible to use a main software running on one of the mentioned computers or a separate computer which controls local client programs. Other options include equal instances of the software who communicate with each other and so on.

Only requirement for this computer program to perform the whole method as described is, that the used program and its respective hardware components are able to perform the method completely and automatically. Such a program can then be stored on a Computer-readable storage medium and/or data carrier signal which cause the involved computers to carry out the method steps of acquiring process data from at least two different sources for the production process and its relevant parameters via a Data Collecting computer, using the acquired process data related to the production process to perform a Process Mapping step via a Process Mapping computer, assigning the acquired process data related to the relevant parameters of the production process to its corresponding process parts by performing a Data Mapping step via a Data Mapping computer, analyzing the therefore mapped process data with a specific software performed on an Analyzing computer thereby identifying and validating one or more existing characteristics related to the quality of the production process and using the identified and validated characteristics to create the production process and/or improve its performance via a Process Performing computer. The storage medium can be stored on any suitable digital memory like an USB drive, a hard disk, a flash drive and so on. From that memory it can also be provided via remote communication means using respective data carrier signals, like ethernet, wired or wireless, or any other suitable network transmission means, for transmitting the software to its target hardware.

### BRIEF DESCRIPTION OF THE DRAWINGS

The system, method and software product according to the disclosed subject matter and functionally advantageous developments of those are described in more detail below with reference to the associated drawings using an example embodiment. In the drawings, elements that correspond to one another are provided with the same reference numerals.

### The Drawings Show:

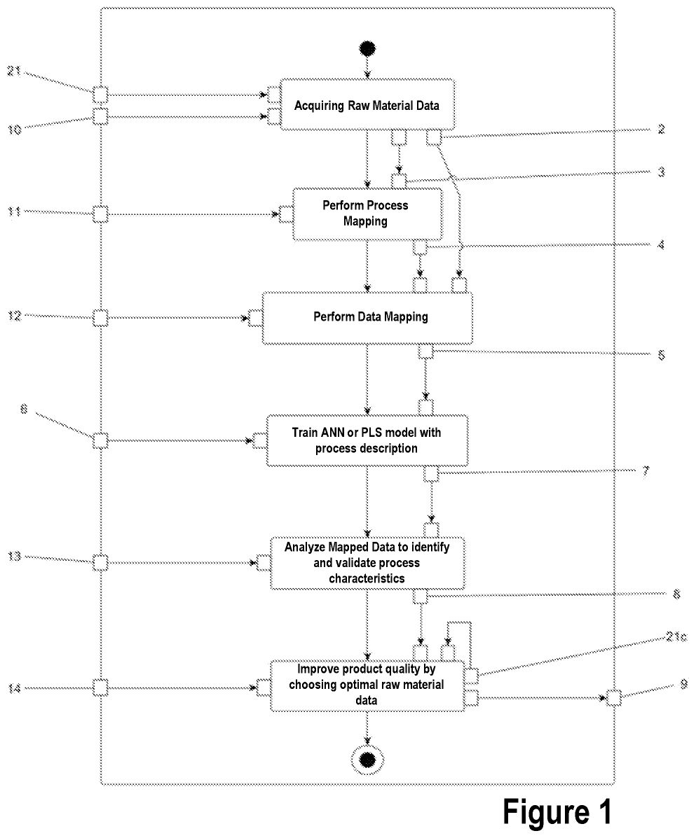

FIG. 1: a general overview about the necessary method steps.

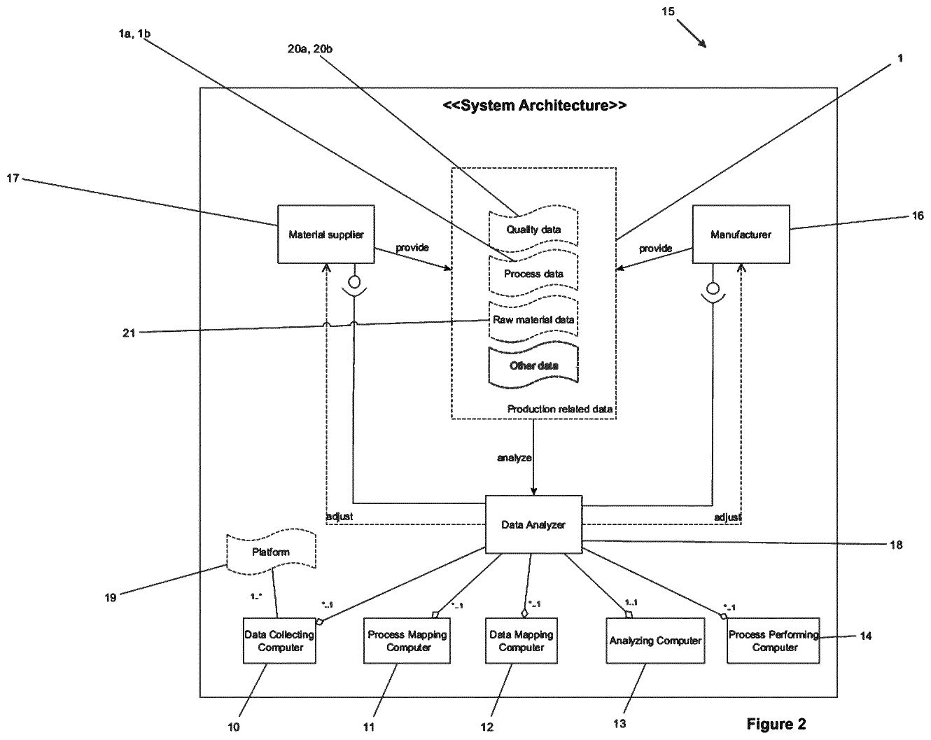

FIG. 2: an schematic overview about the involved system components.

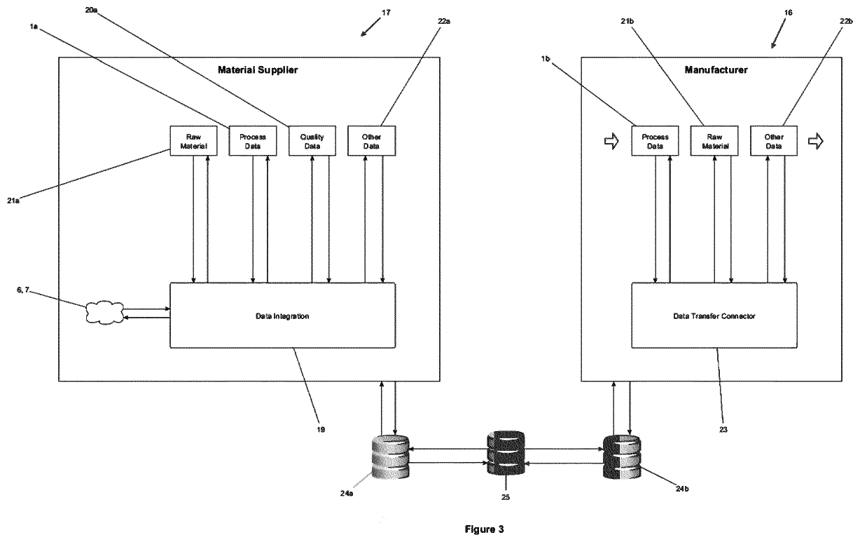

FIG. 3: an schematic overview about two production sites and the process data types they provide.

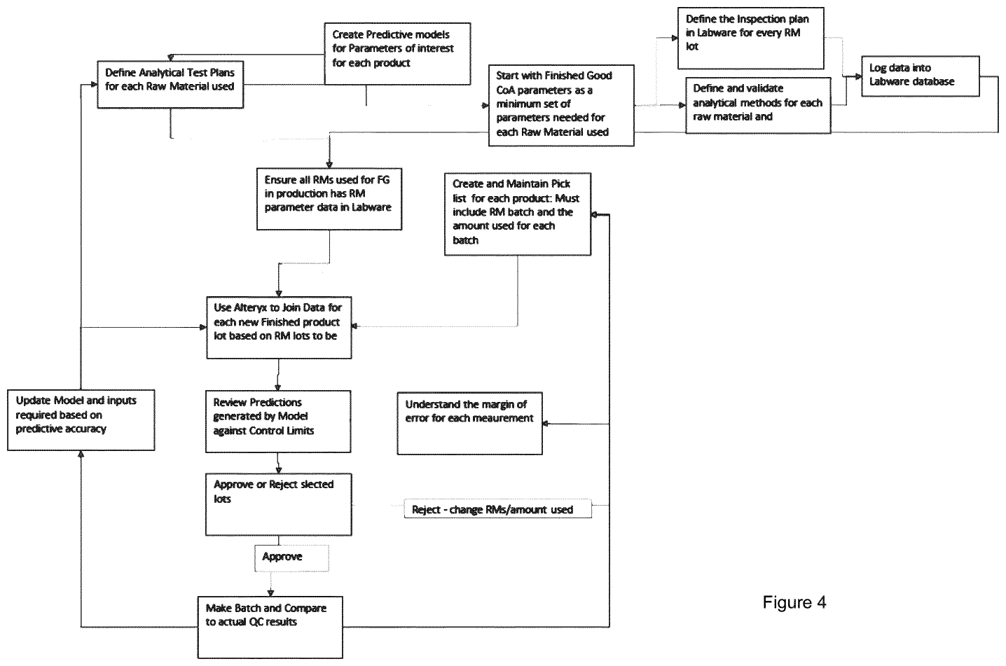

FIG. 4: A flowchart about the specific embodiment process steps.

### DETAILED DESCRIPTION

The disclosed subject matter will be explained in more detail by presenting two example embodiments which disclose respective ways for a proactive quality control system for materials based on data like historical performance, customer factors, attributes, and material processing, raw material, and intermediate factors and attributes.

FIG. 1 shows an overview about the necessary method steps in both embodiments. The steps itself are performed divergent in every exemplary embodiment dependent on the different conditions. The data analysis system 15 which performs the method is shown in FIG. 2. As previously explained its structure can also differ from embodiment to embodiment. Especially the kind of involved computers can differ greatly, depending on how much of the steps is performed by human users with the help of computers and application software or done automatically by specific computers using for instance AI software.

FIG. 3 discloses an schematic overview about two example production sites and the process data types they provide. In this case it is a Material Supplier Site 17 and a Manufacturer Site 16 wherein the Material Supplier Site 17 provides data about raw material 21, process related data 1a, quality data 20a from the Material Supplier, other data 22a and so on. This data is collected by the Data Collecting Computer 10 which performs a Data Integration 19 and provides the data then to the used Data Model 6, 7, like an PLS Model or an artificial neural network. The Manufacturer Site 16 provides data about its own production process 1b, its own quality data 20b, other data 22b etc. This data is then transferred via a Secure Data Transfer Connector 23. The communication of the data between the two sites 16, 17 is performed by web services 24a, 24b which are assigned to the sites. Additionally or alternatively also third party web services 25 can be used. This could be e.g. a centrally managed by a Digital Data Platform.

### First Example Embodiment

This first example embodiment comprises a proactive quality control system for materials before a customer, in most cases the Manufacturer Site 16, process that material. It consists of the described hardware as shown already in FIG. 3.

To ensure the resulting product quality the system needs first to identify key parameters from necessary material that may impact the customer's identified performance indicator beyond the material's certificate of analysis (CoA). Second it is required to identify raw material and intermediate parameters that may affect the key indicators and CoA parameters to predict performance before a material batch is made.

To do so the following steps are performed by the system.

With a first Data acquisition step, data extract scripts are used to retrieve data from multiple databases via the Data Collecting Computer 10. The multiple sourced data is cleaned, transformed, joined, coded, and normalized for customer sharing. These data includes time series process data, like sensor data, temperatures, pressures, tank levels, etc., from the quality control system, raw material data of suppliers' CoA (Certificate of Analysis, e.g. metals), additional internal raw material measurements, like trace metal impurity levels and purity levels, and batch pedigree, meaning which raw material lots and how much were collated into a single datafile.

This datafile is then coded, preferably by giving codenames to the columns in the file and by normalizing data between 0 and 1 for each column except contextual/discrete data such as dates, batch numbers, etc. The source data is also provided by the Material Supplier Site 17 and where it contains contextual and time series data which are coded and normalized as well. The matching key to join customer and material data is the material batch number.

In the next Process Mapping Step a process overview and explanations are provided by manufacturing engineers and quality control personnel and entered into the Process Mapping computer 11.

During the following Data Mapping step all available data is checked by subject matter experts and the physical meaning behind the data is evaluated by applying chemical/process engineering knowledge. In a workshop with several process, quality and data experts, the available data in form of the raw material parameters and/or process parameters is mapped or connected with the data from the process mapping step, like, inline physical parameter measurements etc., by using the Data Mapping computer 12. Customer data is collected from multiple fabs. Sometimes, one finished good batch was used in different fabs resulting in different customer indicator performance.

The most important method step concerns with the Data Analytics. Here all collected and mapped data is matched by the Analyzing computer 13 based on the material batch number with corresponding material batch number. Several suitable data models, like PLS, Random Forest and others, are used in different ways to make predictions indicators, highlight feature importance, and further develop the used models. Validation of the resulting feature importance are done by process experts to rationalize physical phenomena of finding and its validity to the used data model. After validation the next steps are as follows:
1. A list of feature importance by SHAP or Pearson correlation value is created for each model.
2. A model to predict the customer indicators based on valid material feature importance is developed.
3. Models to predict the CoA parameters are developed.
4. Feature importance and model predictions with a random training and validation dataset are validated.
5. Ongoing bias or creep of models is performed to validate and if possible improve the model efficiency.

The results can then be presented to the site owners and other customers. To do so for instance suitable methods of controlling valid parameters with high feature importance are proposed. Tests have shown the used prediction models are proposed with proven efficiency against actual data and provide a good overlap to customer's indicator(s) zone performance. Internal reviews of material batches are supposed to be made and validated with planning, manufacturing, and quality before committing to the production. The models should also continuously reviewed against actual data for model driven efficiency.

### Second Example Embodiment

This second example embodiment also comprises a proactive quality control system for materials. It performs the following process steps.

First a batch automation is established. That means that a finished goods production is automated, e.g. by measuring tank levels and control the amounts of added raw materials, and a data historian is introduced.

Next step is the data acquisition step. Here data is acquired, corrected and integrated by a team of internal IT and process quality experts into an Azure Sequel Abstract Layer (SAL) database running on the Data Collecting Computer 10. This data is about:
Finished goods batches and lot selections from a Picklist SQL database, which is a custom web-based tool used to plan lot selections for upcoming batches, exchanging data with a SAP system
Quality measurements, like trace metals, conductivity, mean particle size, of raw material lots and finished goods batches, as well as customer acceptance limits from a LIMS system Labware
Process data, e.g. sensor data like UPW temperature, differential pressure during filtering, from historian data— including the awareness of effects beyond raw material quality

The process mapping step consist of doing a process overview and drafting explanations for each finished goods product being considered. Additionally process charts and P&IDs are used by process and quality experts to identify all potential influencing factors. Those quality experts are preferably supported by a Process Mapping computer 11.

In the data mapping step for each finished goods product being considered, the available data is mapped with the help of the Data Mapping computer 12 to the relevant process steps drafted by the process/quality experts during the process mapping step. This data comprises e.g. which sensors from historian data are relevant for which product and so on. Also a possible and preferable data cleaning and aggregation is done during this step. The data cleaning bothers with questions like which batches should be to excluded because of incomplete or inconsistent data, as they might still be in transit. The data aggregation considers point like weighted a sum of raw material quality characteristics if several lots of a raw material are blended in a batch or the use average of quality measurements in case of several samples.

An important part of the disclosed embodiments is then the Data Analytics. Here all data is matched to the finished goods batch level by using the batch number or, in case of additional process data, by averaging values during the manufacturing period of the batch. Several data models were tested to predict each finished goods quality parameter, usually about 15 parameters overall, from mass balance models based on raw material lot characteristics and weights, to data-based linear and non-linear models, like OLS, PLS, xgboost and others. The Model performance is evaluated on an unseen test set based on a time-series split of the data, due to the auto-correlated nature caused by overlaps in used raw material lots. Preferably the data models are hosted on the Analyzing computer 13, which can be any suitable computer.

The important influencing factors are then discussed with and validated by process and quality experts. The final data models are reduced to use features available prior to production. For potential process-related influences, substitute data models can be included if needed, e.g. to predict UPW temperature based on outside temperature using lags and/or weather forecasts, which are not in use right now.

To perform the disclosed method it is highly preferable to use a suitable user interface. To do so the Alteryx platform is used for a final data preprocessing and application of deployed predictive data models. The outcome is written to the SQL database on Azure, from where a dedicated Tableau dashboard pulls the data for the Raw Material Review Board (RMRB). For each product and quality measurement under consideration, the dashboard shows available historical measurements and predictions along with customer acceptance limits for past and planned batches. Also, the contributions of different raw materials to the prediction of a certain quality measurement are shown to indicate the most relevant raw materials 21c. A summary is then provided in the dashboard to highlight batches requiring attention because customer acceptance limits are not met.

Both the supply chain planner and the quality experts can review the dashboard to identify potential issues for planned batches. Based on the quality predictions, the supply chain planner can adjust lot selections if needed. Any changes are reflected in the dashboard due to a minutely data refresh. During a weekly meeting, any issues, or special current circumstances, like logistical constraints, customer requirements asking for a certain lot selection, are discussed among the supply chain planner and quality experts to decide on suitable actions.

With this approach realized as an example in the first and second embodiment the batch automation leads to a significant reduction in finished goods quality variation. This allows transparency on expected finished goods quality based on raw material lot selections 21c and predictive models, leading to a further improvement in the lot selection process and less need to rework or scrap batches.

The continuous data integration additionally allows to monitor the prediction quality and improves the used data models based on the ongoing incoming new information. In a further example, the system can also be extended to automate the lot selection in non-edge cases, thus reducing the manual effort of the supply chain planner.

### LIST OF REFERENCES

1 Available production related data
2 Separated parameters of raw material data
3 Separated general Process description
4 Created process charts with process steps
5 Mapped process description with mapped parameters of raw material data
6 Untrained neural network or PLS model
7 Trained neural network or PLS models
8 Identified process characteristics
9 Improved product quality
10 Data Collecting computer
11 Process Mapping computer
12 Data Mapping computer
13 Analyzing computer
14 Process Performing computer
15 Production system
16 Manufacturer Site
17 Material Supplier Site
18 Data Analyzer
19 Digital Data Platform
20a Quality data from Material Supplier
20b Quality data from Manufacturer Site
21 Raw material data
21a Raw material data from Material Supplier Site
21b Raw material data from Manufacturer Site
21c Selected raw material data
22a Other data from Material Supplier
22b Other data from Manufacturer Site
23 Secure Data Transfer Connector
24a Material Supplier Web Service
24b Manufacturer Site Web Service
25 3rd Party Web Service

1.-21. (canceled)

22. A method for ensuring product quality in a process for producing a product from a material comprising the following steps:
acquiring raw material data from at least two different sources for the production process and its relevant parameters by using a Data Collecting computer;
using the acquired raw material data related to the production process to perform a Process Mapping step by using a Process Mapping computer;
assigning the acquired raw material data related to its separated parameters of the production process to its corresponding process parts by performing a Data Mapping step by using a Data Mapping computer to create a mapped process description;
analyzing the therefore mapped process description with a specific software performed on an Analyzing computer thereby identifying and validating one or more existing characteristics related to the quality of the produced product; and
using the identified and validated characteristics to choose the most suitable, available raw material data to improve the resulting product quality.

23. The method of claim 22, wherein for acquiring the data for the production process and its relevant parameters the raw material data is retrieved from a database which is connected to the Data Collecting computer, created by observing the process using data collecting devices, notably sensors, and/or provided by a human user.

24. The method of claim 23, wherein acquiring the data is done during previous executions of the process and/or during a current execution after using the identified and validated characteristics.

25. The method of claim 22, wherein the Process Mapping is performed by describing the structure of the production process or its pre-stages including necessary components, process sequences or process steps, ingredients, especially the raw material and the like.

26. The method of claim 22, wherein the Data Mapping is performed by assigning the acquired raw material data, like temperature, mixing ratio of the raw material, time, and the like, to its corresponding process components and process sequences or steps.

27. The method of claim 22, wherein analyzing the mapped process description is performed by the software using supervised algorithms including a data analysis framework with a data model using approaches like Multivariate Analysis like PLS regression, PCA, Random Forest, XGBoost and artificial neural networks, or the like, or using supervised and/or unsupervised algorithms.

28. The method of claim 27, wherein analyzing the data is performed using mechanistic models, physics based models, models based on (partial) differential equations and models based on quantum chemical computations.

29. The method of claim 27, wherein the structure of the supervised algorithms is the result of training the PLS regression, PCA, Random Forest, XGBoost and artificial neural networks, or the like with the results of the process description from the Process and Data Mapping.

30. The method of claim 22, wherein the raw material data is acquired by examining the at least two different sources either manually by a user who inputs this data in the Data Collecting computer or automatically by a Data Collecting Software performed on either the Data Collecting computer or a separate computer which is connected to it with the Data Collecting Software transmitting it to the Data Collecting computer.

31. The method of claim 30, wherein as at least two different sources at least two different production sites are used.

32. The method according to claim 31, wherein the raw material data from the at least two involved production sites comprises specific quality parameters or metal impurity and purity levels, in-process-data like temperatures, pressures, flows and/or P&ID charts.

33. The method of claim 22, wherein a user interface is implemented which uses a data platform on the Analyzing computer for a preprocessing of the acquired raw material data before applying the specific software performed and writes the results to a database from where a dedicated dashboard retrieves the data to provide it to the user for performing a Raw Material Review.

34. The method of claim 33, wherein the user interface displays the contributions of different raw materials to the prediction of a certain quality measurement to indicate the most relevant raw materials.

35. The method of claim 22, wherein the production process is a semiconductor device manufacturing process using Chemical mechanical planarization.

36. A System for developing or improving a process for producing a product from a material comprising:
a Data Collecting computer with a connected database and/or at least two production sites being used to acquire raw material data from the at least two production sites for the production process and its relevant parameters;
a Process Mapping computer being used to perform a Process Mapping step with the acquired raw material data related to the production process;
a Data Mapping computer being used to assign the acquired raw material data related to the relevant parameters of the production process to its corresponding process parts by performing a Data Mapping step;
an Analyzing computer including a specific software performed on it using supervised algorithms including a data analysis framework with a data model wherein the software analyzes the therefore mapped process description to identify and validate one or more existing characteristics related to the quality of the production process; and
a Process Performing computer being used to create the production process and/or improve its performance on the at least two production sites by applying the identified and validated characteristics.

37. The System according to claim 36, wherein at least one of the at least two sites is a factory for producing chemicals, pharmaceuticals or the like and at least one of the other sites is a chemical material provider and/or distributor.

38. The System according to claim 36, wherein the Data Collecting computer is hosting a computer based digital platform which is used to acquire the raw material data from the at least two production sites.

39. The System according to claim 38, wherein the Process Mapping computer and the Data Mapping computer are supporting input terminals for human users to perform the Process Mapping and Data Mapping step, while the Analyzing computer is a server which hosts the software with the supervised and/or unsupervised algorithms, notably an artificial neural network, and the Process Performing computer is part of or identical to the respective computer based control terminal for the at least two production sites.

40. An XGBoost, Random Forest or artificial neural network which structure is dependent on being trained with specific training data which is created by the following steps:
acquiring raw material data from at least two different sources for the production process and its relevant parameters by using a Data Collecting computer;
using the acquired raw material data related to the production process to perform a Process Mapping step by using a Process Mapping computer; and
assigning the acquired raw material data related to the relevant parameters of the production process to its corresponding process parts by performing a Data Mapping step by using a Data Mapping computer and creating training data from those mapped process description.

41. A Computer program comprising instructions which cause the involved computers to carry out the following method steps:
acquiring raw material data (21, 21a, 21b) from at least two different sources for the production process (3) and its relevant parameters (2) by using a Data Collecting computer (10);
using the acquired raw material data (21, 21a, 21b) related to the production process (3) to perform a Process Mapping step by using a Process Mapping computer (11);
assigning the acquired raw material data (21, 21a, 21b) related to the relevant parameters (2) of the production process to its corresponding process parts (3) by performing a Data Mapping step by using a Data Mapping computer (12);
analyzing the therefore mapped process description (5) with a specific software performed on an Analyzing computer (13) thereby identifying and validating one or more existing characteristics (8) related to the quality or performance of the production process; and
using the identified and validated characteristics (8) to develop the production process or improve its performance.

42. A non-transitory Computer-readable storage medium and/or data carrier signal having stored thereon the computer program of claim 41 which cause the involved computers to carry out the following method steps:
acquiring raw material data from at least two different sources for the production process and its relevant parameters by using a Data Collecting computer;
using the acquired raw material data related to the production process to perform a Process Mapping step by using a Process Mapping computer;
assigning the acquired raw material data related to the relevant parameters of the production process to its corresponding process parts by performing a Data Mapping step by using a Data Mapping computer;
analyzing the therefore mapped process description with a specific software performed on an Analyzing computer thereby identifying and validating one or more existing characteristics related to the quality or performance of the production process; and
using the identified and validated characteristics to develop the production process or improve its performance.
